(19) United States
(12) Patent Application Publication
(10) Pub. No.: US 2020/0097027 A1
(43) Pub. Date: Mar. 26, 2020

(54) METHOD AND APPARATUS FOR CONTROLLING AN UNMANNED AERIAL VEHICLE AND AN UNMANNED AERIAL VEHICLE SYSTEM

(71) Applicant: SZ DJI TECHNOLOGY CO., LTD., Shenzhen (CN)

(72) Inventors: Guanhua SU, Shenzhen (CN); Zhicong HUANG, Shenzhen (CN); Zhaoliang PENG, Shenzhen (CN); Xia CHEN, Shenzhen (CN)

(21) Appl. No.: 16/695,155

(22) Filed: Nov. 25, 2019

Related U.S. Application Data
(63) Continuation of application No. PCT/CN2017/085767, filed on May 24, 2017.

(51) Int. Cl. G05D 1/10; G05D 1/00; B64C 39/02

(52) U.S. Cl. CPC G05D 1/101; B64C 39/024; G05D 1/0094

(57) ABSTRACT

The present disclosure provides an UAV control method. The method includes collecting status information of an UAV during a launch process, the launch process including at least a first time period during which the UAV has not been launched and is under constraint, and a second time period during which the UAV has been launched and is free of constraint; identifying one or more launch actions based on the status information; and controlling movements of the UAV in the second time period based on the identified launch actions.

### CROSS-REFERENCE TO RELATED APPLICATION

This application is a continuation application of International Application No. PCT/CN2017/085767, filed on May 24, 2017, the entire content of which is incorporated herein by reference.

### TECHNICAL FIELD

The present disclosure relates to the field of control, especially in the field of an Unmanned Aerial Vehicle (UAV) control. More specifically, the present disclosure relates to a method and apparatus for controlling an UAV, a control device, and an UAV system.

### BACKGROUND

UAVs are unmanned aerial vehicles that are typically operated using wireless remote control devices and onboard program control devices.

The conventional launch method of an UAV is, for example, placing the UAV at a location, unlocking the motor, and then control the launch using the remote control. For portable UAVs, a dedicated control device (such as a remote control with an operating panel or a mobile device with an interactive display panel) is typically required to wirelessly link to the UAV and send instructions to the UAV. At the same time, the UAV may move in response to the instructions and return the image data captured by an onboard camera, thereby achieving the interaction between the flight control and the image capturing and composition. The conventional launch method of an UAV is a cumbersome process, and the control system is further complicated with the extra control devices.

### SUMMARY

In order to improve the conventional launch method of an UAV, the present disclosure provides a method and apparatus for controlling the launch of an UAV and an UAV system.

One aspect of the present disclosure provides an UAV control method. The method includes collecting status information of an UAV during a launch process, the launch process including at least a first time period during which the UAV has not been launched and is under constraint, and a second time period during which the UAV has been launched and is free of constraint; identifying one or more launch actions based on the status information; and controlling movements of the UAV in the second time period based on the identified launch actions.

Another aspect of the present disclosure provides an apparatus for controlling an UAV, embedded in the UAV. The apparatus includes a storage to store computer executable instructions; and a processor to execute the computer executable instructions stored in the storage to execute an UAV control method. The method includes collecting status information of a UAV during a launch process, the launch process including at least a first time period during which the UAV has not been launched and is under constraint, and a second time period during which the UAV has been launched and is free of constraint; identifying one or more launch actions based on the status information; and controlling movements of the UAV in the second time period based on the identified launch actions.

Another aspect of the present disclosure provides an UAV system. The UAV system includes an UAV body; a propulsion unit placed in the UAV body; and a controller placed in the UAV body. The controller includes a storage to store computer executable instructions; and a processor to execute the computer executable instructions stored in the storage to execute an UAV control method. The method includes collecting status information of a UAV during a launch process, the launch process including at least a first time period during which the UAV has not been launched and is under constraint, and a second time period during which the UAV has been launched and is free of constraint; identifying one or more launch actions based on the status information; and controlling movements of the UAV in the second time period based on the identified launch actions.

### BRIEF DESCRIPTION OF THE DRAWINGS

The present disclosure will be further described in detail below with reference to the accompanying drawings, in which:

FIG. 1 is a schematic diagram of an UAV system according to an embodiment of the present disclosure;

FIG. 2 is a flowchart of an UAV control method according to an embodiment of the present disclosure;

FIG. 3(a) is a schematic illustrating an UAV being launched according to an embodiment of the present disclosure; and FIG. 3(b), FIG. 3(c), and FIG. 3(d) are schematics of illustrating the basic launch types of the UAV shown in FIG. 3(a);

FIG. 4(a) is a schematic illustrating a laterally-launched UAV in a linear launch type according to an embodiment of the present disclosure; and FIG. 4(b) and FIG. 4(c) are schematics of the secondary subtypes of the laterally-launched UAV shown in FIG. 4(a);

FIG. 5(a) is a schematic illustrating a vertically-launched UAV in a linear launch type according an embodiment of the present disclosure; and FIG. 5(b) and FIG. 5(c) are schematics of the secondary subtypes of the vertically-launched UAV shown in FIG. 5(a);

FIG. 6 is a block diagram illustrating an apparatus for controlling an UAV according to an embodiment of the present disclosure; and

FIG. 7 is a block diagram illustrating an onboard control device of an UAV according to an embodiment of the present disclosure.

### DETAILED DESCRIPTION OF THE EMBODIMENTS

Technical solutions of the present disclosure will be described with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

For illustrative purpose only, the terms “above”, “below”, “in front”, “behind”, etc. are used to describe the relative positional relationship of the respective components described in the drawings, and are not intended to limit the scope of the present disclosure. Therefore, without making substantial changes in the technical solution, the relative relationship of the components may be changed or modified, and should be also considered as within the scope of the present disclosure.

It should be noted that, in the description of the present disclosure, the terms “first” and “second” are merely used for conveniently describing different components, and should not be construed as indicating or implying a sequential relationship or relative importance, or implicitly indicating the quantity of indicated technical features. Therefore, the quantity of features defined with “first” and “second” may be explicitly or implicitly at least one.

In the following detailed description, in order to facilitate the explanation, a number of specific details are explained to provide a comprehensive understanding to the embodiments of the present disclosure. However, it is obvious that one or more embodiments may be implemented without these specific details. In other cases, conventional structures and devices are shown in schematic diagrams to simplify the drawings.

In the present disclosure, an UAV may be an unmanned remotely controlled object that may be a movable carrier, such as a remotely controlled unmanned aircraft, a remotely controlled unmanned aerial vehicle, spacecraft, unmanned submersible device, and the like. Further, in the present disclosure, an image capturing device may be an acquisition device for real-time acquisition of still and dynamic images, such as a motion camera equipped on an UAV, an underwater camera equipped on an unmanned submersible device, and the like. Furthermore, in the present disclosure, an onboard control device may be a device mounted on the UAV that may be used to control the UAV and the objects it carries, such as a Pan-Tilt-Zoom (PTZ) platform or a pod.

Specific embodiments of the present disclosure are described below with reference to the accompanying drawings.

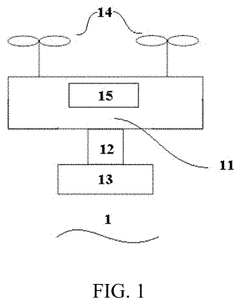

FIG. 1 is a schematic diagram of an UAV system according to an embodiment of the present disclosure. As shown in FIG. 1, the UAV system 1 includes a body 11.

In the present disclosure, the UAV system 1 may include, but is not limited to an unmanned aerial vehicle or an unmanned submersible device, however, such description is not limiting, and any other type of movable object may be launched and travel into its operating space is suitable for the technical solution provided in the present disclosure.

In some embodiments, the UAV system 1 may include a carrier 12 and a load 13. The carrier 12 may allow the load 13 to rotatably or linearly move about one or more axes, where the axes may or may not be orthogonal to one another.

In some embodiments, the load 13 may be fixedly mounted or attached to the UAV system 1 such that the load 13 may maintain in a relatively stationary state relative to the UAV system 1. For example, the carrier 12 connected to the load 13 of the UAV system 1 may not allow the load 13 to move relative to the UAV 1. Further, the load 13 may be directedly mounted on the UAV system 1 without using a carrier.

In some embodiments, the load 13 may include an image capturing device (such as a camera or a camcorder having a visible light imaging device, an infrared imaging device, an ultraviolet imaging device, or the like), an audio acquisition device (such as a parabolic reflexing microphone), etc., which may be integrated into the load 13 to capture visual signals, audio signals, electromagnetic signals, or other desired signals.

In some embodiments, the UAV system may further include a propulsion unit 14. In some embodiments, the propulsion unit 14 may include one or more rotating bodies, propellers, blades, engines, motors, wheels, bearings, magnets, or nozzles. For example, the rotating body of the propulsion unit 14 may be a self-tightening rotating body, a rotating body assembly, or other rotating body propulsion unit. Further, the UAV system 1 may include one or more propulsion units 14, and the propulsion units 14 may be of the same or different types. The propulsion unit 14 may be mounted on the UAV system 1 by any suitable means, such as by a supporting member (such as a drive shaft or a support frame, etc.). The propulsion unit 14 may be mounted at any suitable location of the UAV system 1, such as at the top as shown in the accompany drawings of the present disclosure, or at the bottom, the front end, the rear end, the side, or any combinations thereof.

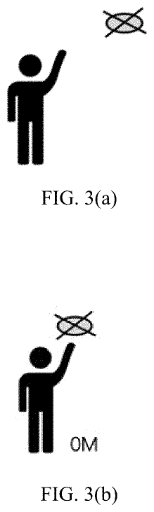

In some embodiments, the propulsion unit 14 may allow the UAV system 1 to launch vertically from the ground, land vertically on the ground, or launch when it is being thrown into the air to initiate a hand-launch. As shown in FIG. 3(a), the UAV does not need to move horizontally (such as sliding on a particular surface). In some embodiments, the propulsion units 14 may allow the UAV system 1 to hover in a predetermined location or direction in the air. Further, one or more propulsion units 14 may be controlled independently of other propulsion units. In some embodiments, one or more propulsion units 14 may be controlled together. For example, the UAV system 1 may include a plurality of horizontally rotating bodies to track the movement of a target. The horizontally rotating body may be actuated to allow the UAV system 1 to vertically takeoff, vertically land, and perform a spiral movement. In some embodiments, one or more of the rotating bodies in the horizontal direction may rotate in a clockwise direction, and the other one or more horizontal bodies in the horizontal direction may rotate in a counterclockwise direction. For example, the number of rotating bodies rotating in the clockwise direction may be the same as the number of rotating bodies rotating in the counterclockwise direction. The rotation rate of each horizontally rotating body may be independently varied to achieve the lift and move operations, thereby adjusting the spatial orientation, speed, and acceleration (for example, relatively up to three degrees of freedom in rotation and translation) of the UAV system 1.

In some embodiments, the UAV system 1 of the present disclosure may further include an onboard control device 15 to provide control data to one or more of the UAV system 1, the carrier 12, or the load 13. The onboard control device 15 may further receive information from one or more of the loads 13, such as information on the location, position, or motion information of the UAV, carrier or the load; and load sensing data, such as image data captured by the camera. In some embodiments, the control data of the onboard control device 15 may include control instructions on the location, movement, and activation of the UAV, carrier, and the load. For example, the control data may change the location or orientation of the UAV (e.g., by controlling the propulsion unit 14), or move the carrier relative to the UAV (e.g., by controlling the carrier 12). The control data of the onboard control device 15 may also control the load, such as controlling the operations of the camera (e.g., capturing still or moving images, zooming, activation, shutting off, switching image capturing mode, changing image resolution, changing focus, changing the depth, changing the exposure, changing viewing angle or field of view). The control data of the onboard control device 15 may further include a sensing device, such as one or more sensors to sense the spatial orientation, velocity, and acceleration (for example, relatively up to three degrees of freedom in rotation and translation) of the UAV system 1. The one or more sensors may include a GPS sensor, a motion sensor, an inertial sensor, a proximity sensor, a pressure sensor, etc. The sensing data provided by the sensing devices may be used to provide sensed information, such as tracking the spatial orientation, the launch pressure, displacement, velocity and acceleration of the UAV system 1, or the attitude of the UAV, carrier, and the load. Further, the sensing device may also be used to collect data on the environment of the UAV, such as climatic conditions, potential obstacles to be approached, location of geographic features, location of man-made structures, and the like. Furthermore, the sensing device may continuously capture the sensing data in real time or at a high frequency.

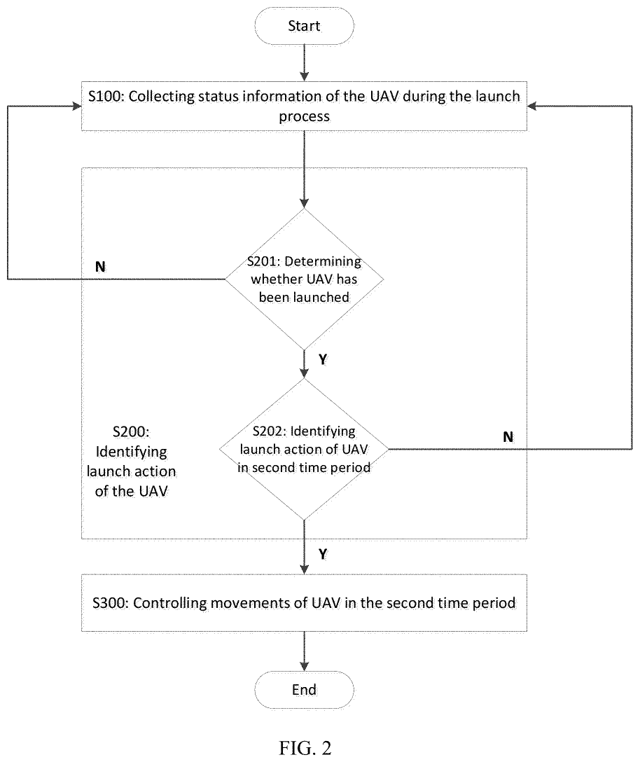

FIG. 2 is a flowchart of an UAV control method according to an embodiment of the present disclosure. The control method includes the following steps:

Step S100, collecting status information of the UAV during the launch process, where the launch process includes at least a first time period when the UAV has not been launched and is continuously or intermittently constrained, and a second time period when the UAV has been launched and is free of constraint.

Step S200, identifying a plurality of launch actions of the UAV based on the status information.

Step S300, controlling the movements of the UAV in the second time period based on the identified launch actions.

Based on the above embodiments, as an example, after determining that the UAV has been launched, status information during the launch process such as the displacement, velocity, acceleration, the integral of the acceleration as a function of the displacement during the launch process, and the pressure (e.g., applied by the human hand) change curve on the UAV over time during the launch process may be collected. Subsequently, the collected status information during the launch process may be used to search in a database containing launch process information and related launch action types stored in a storage device in the onboard control device 15 (e.g., a corresponding lookup table of “Launch Process Information” vs. “Launch Action Types”) to find the matching type of the launch action, thereby identifying the launch actions of the UAV. The identified launch action may be a single type of launch action, or a combination of different types launch actions (that is, a combination of two or more types of launch actions). In an alternative embodiment, when two or more types of launch actions are identified, the magnitude of the motion parameters of each type of launch action, such as the initial velocity, the integral of the acceleration as a function of the displacement, etc., may be used to determine a more obvious single type of launch action, thus determining as the more obvious type of launch action, and other types of hand actions with lower degree of obviousness may be selectively omitted.

After the motor of the UAV has been started, the user may hand-launch the UAV, or use a device that may support the UAV and perform the launch actions to provide an initial velocity to the UAV to launch the UAV. By launching the UAV with a specific action, the control device of the UAV may identify the action (e.g., by identifying the information collected by the Inertial Measurement Unit during the action), to generate a specific instruction that may control the UAV to move along a trajectory associated with the launch action. When the UAV enters the predetermined trajectory, the UAV may start to perform video recording to complete the image capturing of a specific scene at specific viewing angles associated with the trajectory. Hence, an external remote control device such as a remote controller, a control device with a touch screen, etc. may be omitted; and a specific launching site is no longer needed, thereby simplifying the structure of the UAV system, increasing the efficient of the takeoff process of the UAV and its control operations as there is almost no special requirements for the launching site, which further simplifies the UAV system.

In another embodiment, as an example, controlling the movements of the UAV in the second time period S300 may include: associating the type of launch actions with each predetermined trajectory of the UAV after identifying the launch actions based on the status information, so the UAV may travel in the predetermined trajectory. After the UAV is launched, the launch actions used during the launch process that correspond different types of predetermined launch actions (individually or in combination) may be identified, and the identified launch actions may be associated with the corresponding predetermined trajectories. For example, after the launch actions is identified, these actions may be used to search in a “Launch Action Type vs. Predetermined Trajectory” lookup table stored in the storage device in the onboard control device 15 to identify the matching predetermined trajectories. Since the identified launch actions may be a single type or a combination of different types (that is, a combination of two or more launch action types), correspondingly, the matching predetermined trajectories may be a single trajectory or a combination of trajectories (that is, a combination of two or more trajectories). In an alternative embodiment, after identifying two of more types of launch actions, for example, based on the obviousness of the change in the predetermined trajectory over time based on each type of launch actions, a more obvious predetermined trajectory may be determined, and the less obvious predetermined trajectory may be selectively omitted.

By matching the identified type of launch actions with the predetermined trajectories, it is possible to simply determine the trajectory that the UAV may travel without the need for an additional control device, thereby simplifying the structure of the system and improving the automation process of the UAV operation by using the launch actions to select the trajectories of the UAV and the corresponding image capturing trajectories.

In an exemplary embodiment of the present disclosure, the predetermined trajectories and the predetermined image capturing parameters associated with each type of launch actions of the UAV may be different, and the conventional UAV trajectories may be achieved by defining a limited number of representative trajectories and image capturing parameters.

In one embodiment of the present disclosure, as shown in FIG. 2, first, the status information of the UAV during the launch process may be collected in Step S100, where the collection of status information may be performed continuously or intermittently at a sufficiently brief time interval. In particular, the status information collected during the launch process may include, for example, at least one of the following: velocity; acceleration; location; position angle; displacement, distance of the UAV relative to a specified reference object; and the change in the pressure curve of the UAV, etc.

As an example, referring to FIG. 2, the status information collected in Step S100 may be used to identify the launch actions of the UAV in Step S200. For example, an Inertia Measurement Unit (IMU) may be used to identify the movements that need to be performed after the launch. For example, determine whether the UAV has been launched based on the status information; Alternatively, determining whether the UAV has been launched may be completed by setting a predetermined time period that is long enough; after the predetermined time period has elapsed, the UAV may be considered as launched.

In one embodiment of the present disclosure, for example, as shown in FIG. 2, identifying the launch actions of the UAV in Step S200 may further include the following steps:

Step S201, determining whether the UAV has been launched based on the status information; and

Step S202, identifying the launch action of the UAV based on the status information. Further, after determining the UAV has been launched, the launch processing may change from the first time period to the second time period, and start to identify the launch actions of the UAV in Step S202.

In one embodiment of the present disclosure, determining whether the UAV has been launched in Step S201 may include: determining whether the UAV is in a free fall state that may be only subjected to gravity, but not in a vertical direction to determine if the UAV has been launched. When the UAV is launched from the human hand, it is free from the external force of the hand; further, the moment that the UAV is launched, the propulsion unit 14 of the UAV may not provide the lift or sufficient lift to the UAV, so it may be considered that only the gravitational acceleration is received at the moment of launch; furthermore, if the UAV has a vertically downward velocity or speed vector when it is released from the human hand, it may be likely to fall directly from approximately a human's height to the ground, which may not be an optimal condition to perform the launch. Thus, these conditions may not be considered as a type of launch action and launch trajectory, and the UAV may not be controlled to enter any predetermined trajectory. Instead, in the subsequent embodiments of the present disclosure, when such condition is detected, the height of the UAV may be adjusted to a predetermined height, when the height of the UAV reaches the height requirement of the predetermined trajectory, and other requirements also match one or more specific predetermined trajectories, the UAV may enter the specific predetermined trajectory or a combination thereof. More specifically, for example, in response to the UAV being in a state where the acceleration may be substantially the gravitational acceleration, and the velocity is zero or the velocity has a non-zero value without the vertically downward vector, it may be determined that the UAV may be in a state of being released from a continuous constraint.

Alternatively, in one embodiment of the present disclosure, determining whether the UAV has been launched in Step S201 may include: determining whether the pressure on the UAV from the human hand has dropped to zero to determine whether the UAV has left the human hand. More specifically, for example, in response to the state where the pressure curve of the UAV drops to zero, the UAV may be determined to be in a state of being launched from its continuous constraint. More specifically, as an example, determining whether the pressure change curve on the UAV has dropped to zero may include: determining whether the pressure change curve on the UAV has gradually approached and substantially conformed to the pressure curve of the predetermined launch process until the pressure reaches zero; or alternatively, determining whether the pressure change curve on the UAV has reached zero after a predetermined time period. In particular, the former approach determines whether the UAV has left the human hand by comparing the pressure curve of the UAV with a predetermined reference pressure curve to determine whether it matches the pressure curve of the UAV after it leaves the human hand. The latter approach determines whether there is pressure (which may be a counteraction to the supporting force provided by the human hand) on the UAV based on the rating of drop when the pressure curve of the UAV drops to zero, to determine whether the UAV has left the state of being continuously constrained.

Alternatively, in one embodiment of the present disclosure, determining whether the UAV has been launched in Step S201 may include: determining whether the distance (e.g., distance relative to the human hand, distance relative to the human foot, distance relative to the human face, etc.) of the UAV relative to a reference object is long enough to determine whether the UAV has left the human hand. More specifically, for example, in response to the distance between the UAV and a specific reference object exceeds a first distance threshold, the UAV may be determined to be free of the continuous constraint.

Through the above exemplary embodiments, whether the UAV is free of continuous constraint may be determined, and subsequently, the moment at which the UAV leaves the human hand may be determined. Moreover, although only one of the exemplary methods described above is required to effectively determined whether the UAV has left the human hand, two or more exemplary methods may be used simultaneously to ensure the UAV has left the human hand.

However, in practice, there may be instances where the UAV may unintentionally leave the human hand (e.g., when the user's hand slipped, or when the user encounters a bump on the ground, or when the user tosses and catches the UAV in the hand), but UAV may still be considered as in the hands of the user, and such instances may be considered as “pseudo-launches”. To avoid the “pseudo-launches” state being identified as an actual launch, determining whether the UAV has been launched in Step S201 may be done based on the status information collected.

In one embodiment of the present disclosure, for example, when the UAV is determined to be free of continuous constraint, in response to the UAV remains in such state greater than or equal to the first time threshold, the UAV may be determined to be launched. Further, if the UAV remains in such state exceeds the first time threshold, for example, 1.5 second, 2 seconds, etc., the UAV may be considered as being released from the human hand and has not been retrieved, thereby substantially entering a launched state. Thereafter, the UAV may identify the launch action of the UAV in Step S202 based on the status information.

As an example, identifying the launch action of the UAV in Step S202 may be done by detecting one or more of the velocity, acceleration, or displacement of the UAV between the end segment of the first time period and the beginning segment of the second time period, to identify one or more of the predetermined launch action types of the UAV.

FIG. 3(a) is a schematic illustrating an UAV being launched according to an embodiment of the present disclosure; and FIG. 3(b), FIG. 3(c), and FIG. 3(d) are schematics of illustrating the basic launch types of the UAV shown in FIG. 3(a).

The predetermined types of launch actions may include several basic types. For example, as shown in FIG. 3(b) to FIG. 3(d), the plurality of launch action types may include at least: a flat launch, a linear launch, and a circular launch. As shown in FIG. 3(b) to FIG. 3(d), a flat launch may be when the UAV is launched in a horizontally flat state; a linear launch may be when the UAV is launched from the launch point in a generally unidirectional direction; and the circular launch may be when the UAV is launched in a way that spirals outward from a generally specific point (e.g., the launch point, or a point at a predetermined distance from the launch point, such as the location at which the user launching the UAV is standing, where the predetermined distance may be the distance from where the user stands to the hand that is launching the UAV).

As an example, identifying one or more of the predetermined types of launch actions of the UAV may include: identifying the type of launch action by detecting one or more of the following attributes: the direction of the acceleration or the velocity at the end segment of the first time period, or, the direction of the velocity at the beginning segment of the second time period.

In the embodiments of the present disclosure, since the velocity and acceleration vectors of the basic types of the three exemplary launch actions described above differ greatly (e.g., whether the speed is not at zero, and the specific operating forms), the launch action type in Step S202 may be identified.

More specifically, for example, as shown in FIG. 3(b), in response to the UAV maintaining in a zero-speed state, the launch action may be identified as the flat launch, where the speed in a specific time period in the first time period may be zero. In particular, the velocity at the end segment of the first time period may be zero, or the velocity during the entire first time period may be zero, then the launch action may be identified as the flat launch. As an example, as shown in FIG. 3(c) and FIG. 3(d), in response to the angle between the direction of acceleration of the UAV at the end segment of the first time period and the direction of the velocity at the beginning segment of the second period is less than a predetermined angle threshold, the launch action may be identified as the linear launch. Correspondingly, in response to the angle between the direction of acceleration of the UAV at the end segment of the first time period and the direction of the velocity at the beginning segment of the second period is greater than the predetermined angle threshold, the launch action may be identified as the circular launch.

As an alternative embodiment, for example, in response to a velocity vector responsive to the UAV at the beginning segment of the second time period including the velocity vector from the position of the UAV away from the position of the UAV at the end segment of the first time period, and the velocity may have one or more vectors in the horizontal direction and the vertical direction (i.e., there is a component in the horizontal direction or a component in the vertical direction), the launch action may be identified as the linear launch. In addition, in response to the velocity of the UAV at the beginning segment of the second time period including a first velocity vector from the position of the UAV towards the position of the UAV at the end segment of the first time period, and a second velocity vector at an angle (e.g., perpendicular) of the first velocity vector, and the first velocity vector may have one or more vectors in the horizontal direction and the vertical direction (e.g., the first velocity vector is a radial velocity component directed to a fixed point, and the second velocity vector is a tangential velocity component perpendicular to the radial velocity component), the launch action may be identified as the circular launch.

Further, in response to the velocity of the UAV at the beginning segment of the second time period including the first velocity vector from the position of the UAV towards the position of the UAV at the end segment of the first time period, and the second velocity vector at an angle (e.g., perpendicular) of the first velocity vector, and the first velocity vector may have one or more vectors in the horizontal direction and the vertical direction (e.g., the first velocity vector is a radial velocity component that points away from a fixed point, and the second velocity vector is a tangential velocity component that is perpendicular to the radial velocity component), the launch action may be identified as a curved motion, which may be considered as a combination the linear launch and the circular launch, and the velocity components in the direction of the line between the position of the UAV and the position of the UAV at the end of the first time period may deviate from the position of the UAV at the end segment of the first time period. Since the velocity and acceleration vectors of the basic types of the three exemplary launch actions described above differ greatly (e.g., zero speed, angle between the velocity vector, and the velocity vector after the UAV is launched), the difference between different launch action types may be easily distinguished.

In addition, for the sake of simplicity, in an alternative embodiment, the launch actions may be identified by the location of the acceleration at the end segment of the first time period, the velocity at the beginning segment of the second time period, or based on the user setting.

In an alternative exemplary embodiment, for example, the plurality of predetermined launch action types may include at least: a flat launch, a linear launch, and a circular launch; and identifying the plurality of predetermined launch action types may include at least the detection of a motion trajectory of the UAV under a predetermined condition in the first time period to directly identify the type of launch action. More specifically, for example, identifying the type of launch action may include one or more of the following: in response to a state where the motion trajectory of the UAV under the predetermined condition in the first period is a point, the launch action may be determined as the flat launch; in response to a state where the motion trajectory of the UAV under the predetermined condition in the first period is a line, the launch action may be determined as the linear launch; or in response to a state where the motion trajectory of the UAV under the predetermined condition in the first period is a curve, the launch action may be determined as the circular launch. In particular, the predetermined condition may be a time period, a length of motion, a specified pressure, etc. In addition, the motion trajectory may be acquired using an Inertial Measurement Unit (IMU) carried by the UAV, a Global Navigation Satellite System (GNSS that may include GPS, GLONASS, Galileo, Beidou Navigation Satellite System, etc.)

In one embodiment of the present disclosure, correspondingly, when controlling the movements of the UAV in the second time period in Step S300, the respective associated predetermined trajectories may be matched to the identified basic types of exemplary launch actions. More specifically, the predetermined trajectories may include the following basic types: a hovering position, a translational trajectory, and a circular trajectory. The hovering position may be, as shown in FIG. 3(b), in response to the launch action being identified the flat launch, the trajectory of the UAV may be controlled to hover at the location at the beginning segment of the second time period. The translational trajectory may be, as shown in FIG. 3(c), in response to the launch action being identified the linear launch, the trajectory of the UAV may be controlled to perform a translational motion starting from the location at the beginning segment of the second time period. The circular trajectory may be, as shown in FIG. 3(d), in response to the launch action being identified the circular launch, the trajectory of the UAV may be controlled to perform a circular motion that may extend helically (for example, a curve that gradually expands outward relative to the center, such as an involute) around a predetermined specific location (for example, the location of the UAV at the beginning segment of the second time period, or the location of the user or device that launch the UAV at the time of the launch).

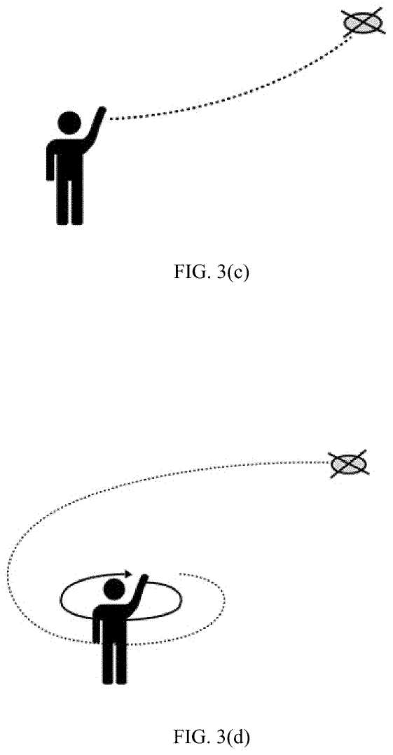

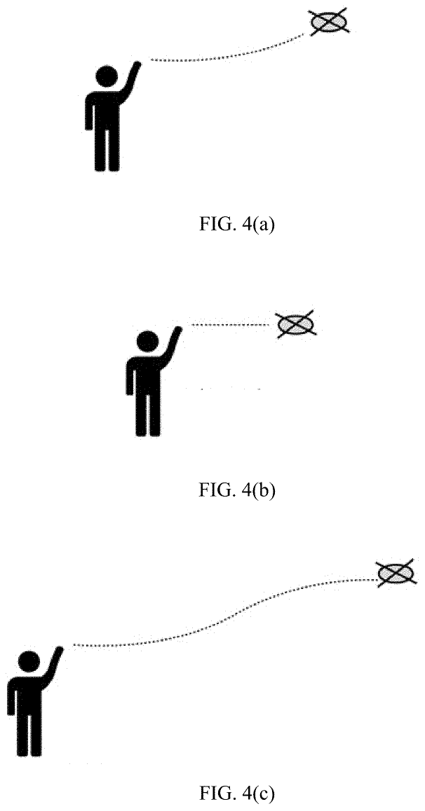

FIG. 4(a) is a schematic illustrating a laterally-launched UAV in a linear launch type according to an embodiment of the present disclosure; and FIG. 5(a) is a schematic illustrating a vertically-launched UAV in a linear launch type according an embodiment of the present disclosure.

As an example, the launch action of the linear launch type may be further subdivided to correspond to different launch trajectories.

In the embodiments of the present disclosure, for example, as shown in FIG. 4(a) and FIG. 5(a), the linear launch type may be further subdivided into one or more of the following subtypes: a lateral launch or a vertical launch. As an example, when the launch action is identified as the linear launch, identifying the type of launch action may include: detecting the direction of the acceleration at the end segment of the first period or the direction of the velocity at the beginning segment of the second period to identify the subtype of the linear launch.

In the embodiments of the present disclosure, since the two exemplary subtypes of linear launch described above differ greatly in their respective directivity, it may be possible to further identify the launch action type in Step S202 based on this principle.

More specifically, for example, the subtypes of the linear launch are shown in FIG. 4(a) and FIG. 5(a), respectively. During the launch process, when the UAV is linearly launched, the specific launch actions may be significantly different in terms of directivity, and thus may be subdivided into the two subtypes (the lateral launch and the vertical launch) mentioned above. The directivity of the launch action is particularly obvious at the second time period of the launch, especially the direction of the initial velocity in the beginning segment. The moment the UAV is launched from the human hand, the acceleration of the UAV may be considered as the gravitation acceleration, therefore, the direction of the initial velocity of the UAV launched from the human hand may depend on the integral of the acceleration vector during the entire launch process. More specifically, when the UAV is in the first time period during which the UAV has not been launched and may be subjected to continuous or intermittent constraints, the initial velocity may be essentially derived from a vector integral of the displacement of the UAV along the acceleration vector at the end segment of the first time period, whereby the direction of the initial velocity of the UAV at the beginning segment of the second time period may be determined by the direction of the acceleration vector in the end segment of the first time period, or the vector integral of the acceleration along the displacement. At the same time, since the integral of the velocity vector may be substantially directly obtained from the integral of the acceleration vector in a complete acceleration process from zero velocity, hence, the direction of the initial velocity of the UAV may also be determined by the integral of the velocity vector at the entire end segment of the first time period from zero velocity. Thereby, the direction of the initial velocity of the UAV can be determined by detecting the direction of the acceleration and/or the direction of the velocity in the entire end segment of the first time period.

In addition, to simplify the process, in an alternative embodiment, the initial velocity may be determined based on the acceleration vector and the velocity vector at a time period between the end segment of the first time period until the time when the UAV may be determined to be launched, thereby eliminating the need to investigate a single acceleration vector integral throughout the process of the UAV acceleration during the launching process. For example, to simplify the process, a fixed velocity may be set as the initial velocity.

In one embodiment of the present disclosure, as shown in FIG. 4(a), in response to the UAV having an acceleration in the horizontal direction at the end segment of the first time period, or a velocity in the horizontal direction at the beginning segment of the second time period, the linear launch may be determined to be the lateral launch. In addition, as shown in FIG. 5(a), in response to the acceleration of the UAV at the end segment of the first time period, or the velocity in the beginning segment of the second time period being substantially along the vertical direction, the linear launch may be determined to be the vertical launch. More specifically, for example, an acceleration ratio threshold between the vertical component and the horizontal component of the acceleration vector may be predetermined, or a velocity ratio threshold between the vertical component and the horizontal component of the velocity vector may be predetermined. Thus, in the case where the acceleration ratio between the vertical component and the horizontal component of the actual acceleration vector is greater than the acceleration ratio threshold, it may be determined that the direction of the acceleration may be substantially along the vertical direction. Alternatively, when the velocity ratio between the vertical component and the horizontal component of the actual velocity vector is greater than the velocity ratio threshold, it may be determined that the direction of the velocity may be substantially along the vertical direction.

FIG. 4(b) and FIG. 4(c) are schematics of the secondary subtypes of the laterally-launched UAV shown in FIG. 4(a).

In another embodiment of the present disclosure, for example, as shown in FIG. 4(b) to FIG. 4(c), the lateral launch may be further subdivided into at least two secondary subtypes, namely a soft launch and a hard launch. In the exemplary embodiment of the present disclosure, compare to a hard launch, when the UAV is launched using the soft launch, since the required initial velocity is low, the required acceleration in the first time period of the launching process may be correspondingly low, so it may be easy to maintain a substantially horizontal trajectory in the shorter amount of time to complete the movement in the horizontal direction. Correspondingly, compare to the soft launch, when the UAV is launched using the hard launch, in addition to the velocity having a horizontal component, the horizontal acceleration in the first time period of the UAV launching process may be higher, the initial velocity may be higher, and the travel time may be longer. Therefore, during this period, the lift provided by the propulsion unit 14 carried by the UAV, which is intended to at least partially balance the gravity and correct the trajectory of the vertical direction, may result in a more pronounced vertical component than the soft launch action. Hence, the soft launch with lower initial velocity of the UAV may be identified as the flat launch, and the hard launch with higher initial velocity of the UAV may be identified as an oblique launch, as shown in FIG. 4(b) to FIG. 4(c).

As an example, when a linear launch is identified as a lateral launch, identifying the subtypes of the linear launch may further include: detecting a velocity vector at the beginning segment of the second time period and/or a vector integral of an acceleration at the end segment of the first time period along the displacement of the UAV to identify the secondary subtype of the lateral launch.

In one embodiment of the present disclosure, during the lateral launch, the UAV may have an acceleration in the horizontal direction at the end segment of the first time period, or a velocity at the beginning segment of the second time period, and the initial velocity in the horizontal direction immediately after the launch may be mainly subjected to the acceleration vector (especially the horizontal component of the acceleration vector) in the first time period, especially near the end segment of the first time period; in addition, the initial velocities of the UAV at the beginning segment of the second time period are different between the soft launch and the hard launch, and correspondingly, the magnitude of the integral of the acceleration along the displacement of the UAV at the end segment of the first time period may be different as well, therefore, based on this principle, the launch action type may be identified in Step S202.

More specifically, in one embodiment of the present disclosure, as shown in FIG. 4(b), in response to the velocity UAV is substantially along the horizontal direction, and the magnitude of the velocity does not exceed the first speed threshold, or the integral of the acceleration along the displacement of the UAV at the end segment of the first time period does not exceed a first integral threshold, the lateral launch may be identified as the soft launch. In addition, as an example, as shown in FIG. 4(c), in response to the UAV's velocity having a horizontal component, and the speed is greater than or equal to the first speed threshold, or the integral of the acceleration along the displacement of the UAV at the end segment of the first time period exceeds the first integral threshold, the lateral launch may be identified as the hard launch. In another embodiment, in response to the UAV's velocity having a horizontal component, and the speed is less than or equal to the first speed threshold, or the integral of the acceleration along the displacement of the UAV at the end segment of the first time period is less than the first integral threshold, the lateral launch may be identified as a combination of a soft launch in the horizontal direction and a vertical launch in the vertical direction. Since there may be a difference in the initial velocities of the UAV in the beginning segment of the second time period between the soft launch and the hard launch, that is, there may be a difference in the integral of the acceleration along the displacement of the UAV at the end segment of the first time period, therefore, by defining the first speed threshold or the first integral threshold, it may be possible to distinguish whether the UAV is soft-launched or hard-launched when the UAV has been identified as laterally-launched.

In the embodiment of the present disclosure, correspondingly, when controlling the UAV in the second time period in Step S300, the subtypes and secondary subtypes of the identified exemplary launch actions may be matched with their respective predetermined trajectories. More specifically, when a linear launch is being identified as a lateral launch, the lateral trajectory may include a soft launch trajectory and a hard launch trajectory. The soft launch trajectory may be, as shown in FIG. 4(b), in response to the lateral launch being identified as the soft launch, the UAV may start the horizontal travel from the location at the beginning segment of the second time period, and the horizontal displacement may be a first predetermined distance, for example, the UAV may fly 1-2 meters horizontally. The hard launch trajectory may be, as shown in FIG. 4(c), in response to the lateral launch being identified as the heavy launch, the UAV may start the oblique travel that may be inclined at an angle with respect to the horizontal direction from the position at the beginning segment of the second time period, and the horizontal displacement may be a second predetermined distance that may be greater than the first predetermined distance, for example, the UAV may fly 10-40 meters along a horizontally inclined S-shaped line along the direction of the oblique acceleration, velocity, or displacement. In some embodiments, for example, different first predetermined distances and second predetermined distances may be pre-stored in a corresponding “Launch Action Type vs. Predetermined Trajectory” lookup table in the storage in the onboard control device 15 of the UAV as a parameter of the predetermined trajectory of the lateral launch.

FIG. 5(b) and FIG. 5(c) are schematics of the secondary subtypes of the vertically-launched UAV shown in FIG. 5(a).

In another embodiment of the present disclosure, for example, as shown in FIG. 5(b) to FIG. 5(c), the vertical launch may be further subdivided into at least two secondary subtypes, namely a soft push launch and a hard push launch.

As an example, when a linear launch is identified as a vertical launch, identifying the subtype of the linear launch may further include: detecting the velocity at the beginning segment of the second time period, and the integral of the acceleration at the end segment of the first time period along the displacement of the UAV to identify the secondary subtype of the vertical launch.

In the embodiment of the present disclosure, since during the vertical launch, the initial velocity of the UAV in the vertical direction immediately after it is launched may be mainly affected by the vertical acceleration in the first time period, especially at the end segment of the first time period. Further, the magnitudes of the initial vertical velocity of the UAV at the beginning segment of the second time period may be different between the soft push and the hard push, and correspondingly, the magnitudes of the integral vertical acceleration along the displacement of the UAV at the end segment of the first time period may be different as well. Therefore, identifying the launch action type in Step S202 may be done based on this principle.

More specifically, in the embodiment of the present disclosure, as shown in FIG. 5(b), in response to the speed of the UAV does not exceed the second speed threshold, or the integral of the acceleration at the end segment of the first time period along the displacement of the UAV does not exceed a second integral threshold, the vertical launch may be identified as the soft push launch. In addition, as an example, as shown in FIG. 5(c), in response to the speed of the UAV is greater than or equal to the second speed threshold, or the integral of the acceleration at the end segment of the first time period along the displacement of the UAV is greater than or equal to the second integral threshold, the vertical launch may be identified as the hard push launch.

Since there may be a difference in the initial vertical velocities of the UAV at the beginning segment of the second time period between the soft push launch and the hard push launch, that is, there may be a difference in the integral vertical acceleration along the displacement of the UAV at the end segment of the first time period, therefore, by defining the second speed threshold or the second integral threshold, it may be possible to distinguish whether the UAV is soft push-launched or hard push-launched when the UAV has been identified as vertically-launched.

In one embodiment of the present disclosure, correspondingly, when controlling the UAV in the second time period in Step S300, the subtypes and secondary subtypes of the identified exemplary launch actions may be matched with their respective predetermined trajectories. More specifically, when a linear launch is identified as a vertical launch, the vertical trajectory may include a soft push launch trajectory and a hard push launch trajectory. The soft push launch trajectory may be, as shown in FIG. 5(b), in response to the vertical launch being identified as the soft push launch, the UAV may perform the vertical travel with a vertical displacement of a third predetermined distance from the location at the beginning segment of the second time period. For example, the UAV may fly up vertically by 0.3-1 meter and may not fall back until it completes the assigned tasks at that height, or before an expected stay time. The hard push launch trajectory may be, as shown in FIG. 5(c), in response to the vertical launch being identified as the hard push launch, the UAV may perform the vertical travel with a vertical displacement of a fourth predetermined distance, which is greater than the third predetermined distance, from the location at the beginning segment of the second time period. For example, the UAV may fly up vertically 3-20 meters, and may not fall back until it completes the assigned tasks at that height, or before the expected stay time. In some embodiments, for example, different third predetermined distances and fourth predetermined distances may be pre-stored in a corresponding “Launch Action Type vs. Predetermined Trajectory” lookup table in the storage in the onboard control device 15 of the UAV as a parameter of the predetermined trajectory of the lateral launch.

In one embodiment of the present disclosure, for example, moving the UAV along the predetermined trajectory may include: in response to identifying a single launch action, controlling the UAV to follow the associated predetermined trajectory; or, in response to identifying two or more single launch actions, controlling the UAV to follow a combination of the two or more associated predetermined trajectories. For example, the “Launch Action Type vs. Predetermined Trajectory” lookup table pre-stored in the storage of the onboard control device 15 of the UAV may be searched to find one or more predetermined trajectories that may match the launch action type during the launch process; in response to identifying two or more single launch action types, controlling the UAV in Step S300 by instructing the UAV to move according to a combination of predetermined trajectories in the second time period.

In addition, in one embodiment of the present disclosure, for example, when controlling the UAV in the second time period in Step S300, while controlling the UAV to move according to the predetermined trajectory, the image capturing device carried by the UAV may be controlled to capture images based on the predetermined image capturing parameters. For example, the predetermined image capturing parameters may be used to capture the panoramic view of the environment in which the target may be located. As an example, each launch action type may be associated with a predetermined image capturing parameters; and the image capturing device carried by the UAV may be controlled to capture images based on the predetermined image capturing parameters. More specifically, for example, when the UAV is launched from the launch point (for example the final location of the user's hand at the time of the launch) and is moving around the launch point, the carrier 12 (e.g., a PTZ) of the UAV along with the load 13 (e.g. a camera) it carries in combination may lock on an operating target (e.g., an object to be photographed). More specifically, for example, the predetermined image capturing parameters may include predetermined composition rules to ensure the target may be in the predetermined composition position when the UAV is traveling in the associated predetermined trajectory. For example, the composition rules may divide the viewing field of the camera into two or more sub-areas using one or more lines (e.g., dichotomy composition, or quadrature composition), or a grid area using a plurality of lines (e.g., a nine-square grid pattern, or a 4×4 gird composition), and place a predetermined composition point, for example, at intersections where lines intersect, as the target to which the camera may be aiming. For example, when controlling the UAV in the second time period in Step S300, the trajectory of the UAV or the pitch of the PTZ may be controlled to execute the composition rules.

More specifically, in the embodiments of the present disclosure, for example the composition rules may include the target being substantially in front of the nose of the UAV, and controlling the UAV in the second time period may include: adjusting the position of the UAV in the associated predetermined trajectory or the combination of the associated predetermined trajectories using the composition rules based on the status information of the UAV; and further adjusting the horizontal position and the tilt angle of the image capturing device carried by the UAV to ensure the target may be in the predetermined composition position. Therefore, it may be possible to accurately and quickly place the target into the desired composition position based on the predetermined composition rules efficiently without an additional external control device and related manual control operations, thereby completing the imaging capture tasks of the UAV with the highest efficiency. For example, the distant view to be photographed may be placed at a position approximately ⅓ of the imaging capturing window of the image capturing device.

The UAV may be supported by user's hand before the launch, and the support of the UAV may be removed immediately after launch. During this process, after the UAV is completely separated from the hand, the propulsion unit 14 may have yet to provide the lift or have yet to respond to the identified launch actions, the UAV may be only subjected to the gravitational acceleration for a limited period of time, which may affect the height of the launch, and may result in a difference in height between the actual trajectory and the corresponding predetermined trajectory during the limited period of time after the launch, and the final trajectory may not match the predetermined trajectory. Therefore, it may be necessary to adjust the height of the actual trajectory during the launching process to meet the desired trajectory as early as possible.

More specifically, as an example, controlling the UAV in the second time period may further include: adjust the height of the UAV, where: in response to the determining the UAV has not been launched, control the power source of the UAV to operate in an idle state based on the detected position of the UAV; and, in response to determining the UAV has been launched and the UAV is in the second time period, use an open-loop control method to control the power source of the UAV to quickly increase the output power from the idle state so the height of the UAV may substantially reach the height of an associated predetermined trajectory or a combination of the associated predetermined trajectories within a predetermined second time threshold. Due to the open-loop control method, the second time threshold may be set to be less than a closed-loop control method. To ensure the accuracy and convergence of the height adjustment of the UAV, a closed-loop control method may be added at the end of the height adjustment.

Similarly, in the horizontal direction, for example, since the predetermined trajectory typically has a limited path length, it is necessary to track the cumulative travel length, so the travel path may be accurately identified when the UAV travels along the predetermined trajectory to reach to a predetermined end point. In addition, there may be a possible difference between the actual trajectory and the corresponding predetermined trajectory in the horizontal direction during the limited period of time, and the final trajectory may not match the predetermined trajectory. Therefore, it is necessary to determine the horizontal travel of the UAV during the launching process to facilitate adjustment to meet the desired predetermined trajectory as early as possible.

More specifically, as an example, controlling the UAV in the second time period may further include: determining the location of the UAV in the associated predetermined trajectory based on the acquired status information.

Further, controlling the UAV in the second time period may further include: in response to the result of the determination of the location of the UAV in the associated predetermined trajectory, adjust the speed of the UAV, for example, decelerate the UAV before reaching the end point, decelerate at a constant or variable speed, or accelerate followed by decelerate, to control the UAV to terminate the travel at the end point of the predetermined trajectory. Furthermore, as an example, the speed adjustment of the UAV may include using the close-loop control method to control the UAV to terminate the travel at the end point of the predetermined trajectory and remain hovering. In addition, the close-loop control method may include one of the following control methods: a Proportional Integral Derivative (PID) control, or a Proportional Derivative (PD) control.

In addition, controlling the UAV in the second time period may further include: returning the UAV to the location at the beginning segment of the second time period, or a predetermined terminal point after reaching the end point.

In the embodiments of the present disclosure, during the launching process, control the UAV to travel in the second time period in Step S300 may also require the controlling of the propulsion unit 14 to stabilize the UAV to ensure the carrier 12 carried on the UAV and the load 13 its carries may be stabilized. For example, controlling the UAV to travel in the second time period to self-stabilize may further include: after determining the location of the UAV is in the associated predetermined trajectory to determine that the UAV has not reach the end point of the respective predetermined trajectory, based on the collected status information, using a position algorithm, calculate the difference of the pitch axis and the roll axis of the UAV between at the current position and the position at the end of the first time period; correspondingly adjusting the pitch axis and the roll axis of the UAV to a predetermined angle range; and control the UAV's propulsion unit so the UAV may maintain a self-stabilizing state parallel to the ground.

In practice, the hand-launch of the UAV is different from other modes of use that may require precise manual control using an external control device, so it may be necessary to lock the hand-launch mode when it does not need to be used and activate the hand-launch mode when necessary. More specifically, as an example, the control method may further include trigging the actions of the UAV prior to collecting the status information of the UAV during the hand-launch process. For example, a trigger signal of the UAV may be monitored in real time, and in response to detecting the trigger signal of the UAV, start the UAV and trigger the actions of the UAV.

In some embodiments, the trigger signal may include one or more of the following: tapping the UAV one or more times; clicking a power button or a control button of a control device in communication with the UAV one or more times; drawing a predetermined pattern on a touch screen or a touch panel of the control device; recognizing human body features of the user and compare them to the stored user features (e.g., face recognition, voice recognition, fingerprint recognition, iris recognition, scleral recognition, etc.), or the combinations thereof.

Further, when executing the hand-launch, if the attitude angle is incorrect (e.g., the body may be tilting at a certain angle towards the ground), the launch may fail or malfunction easily, therefore, it may be necessary to detect the attitude angle and determine whether the detected attitude angle is acceptable. More specifically, the status information may include the attitude angle, and determining the launch actions of the UAV may include detecting the attitude angle of the UAV, which may include determining whether the attitude angle of the UAV is within a range of attitude angle thresholds suitable for safely unlocking the UAV, and in response to a attitude angle exceeding the range of attitude angle thresholds, send an alarm signal and revert the triggering actions of the UAV.

The technical solution for controlling the launch of the UAV in accordance to the embodiments of the present disclosure has been described in detail with reference to the accompanying drawings.

Through the method for controlling the launch of the UAV above, the launch of the UAV may be done without special requirement on the launch site, and the movements of the UAV and its trajectory may be controlled by recognizing the launch actions of the UAV, which may simplify the control system of the UAV without using an additional external device to communicate to the UAV and simplify the operation of the UAV, and the control flow of the UAV may be achieved without any manual input instructions and subsequent tracking control during and after the launch.

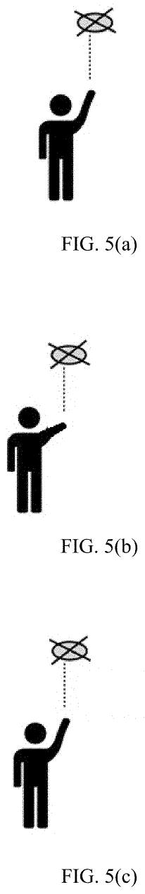

The structure of an apparatus for controlling the launch of the UAV in accordance with an embodiment of the present disclosure will be described in detail below in conjunction with FIG. 6.

FIG. 6 is a block diagram illustrating an apparatus for controlling an UAV according to an embodiment of the present disclosure. Referring to FIG. 6, the control apparatus includes a collection module 100 for collecting status information of the UAV during the launch process, where the launch process includes at least a first time period in which the UAV has not been launched and is in a continuous or intermittent constraint, and a second time period in which the UAV has been launched and is unconstrained; an identification module 200 for identifying the launch actions based on the status information; and an instruction module 300 for controlling the movements of the UAV during the second time period based on the identified launch actions.

Based on the above embodiment, as an example, after determining that the UAV has been launched, status information during the launch process such as the displacement, velocity, acceleration, integral value of the acceleration along the displacement of the UAV during the launch process, and pressure (e.g., applied by the human hand) change on the UAV over time during the launch process may be collected. Subsequently, the collected status information during the launch process may be used to search in a database containing launch information and launch action types stored in a storage device in the onboard control device 15 (e.g., a corresponding lookup table of “Launch Process Information” vs. “Launch Action Type”) to find the matching type of the hand-launch action, thereby identifying the launch actions of the UAV.

The identified launch actions may be a single type of launch action, or a combination of different types launch actions (that is, a combination of two or more types of launch actions). In an alternative embodiment, when two or more types launch actions are identified, the magnitude of the motion parameters of each type of launch action, such as the initial velocity, the integral value of the acceleration with the displacement, etc., may be used to determine a more obvious type of launch action, thus determining the more obvious type of launch action, and other types of launch actions with lower degree obvious may be selectively omitted.

After the motor of the UAV is started, the user may hand-launch the UAV to provide the initial velocity to the UAV, and subsequently launch the UAV with specific launch actions. The control device of the UAV may identify the action (e.g., by identifying the information collected by the IMU during the action), to generate a specific instruction that may control the UAV to move in a trajectory associated with the launch actions. When the UAV enters the predetermined trajectory, the UAV may start to perform video recording to complete the image capturing of a specific scene at specific viewing angles associated with the trajectory. Hence, the structure of the UAV system may be simplified, thereby increasing the efficiency of the takeoff process of the UAV and its control operations.

In another embodiment, as an example, the instruction module 300 may be used to control the movements of the UAV in the second time period. More specifically, the instruction module 300 may associate the type of launch action with each predetermined trajectory of the UAV after it identified the launch actions based on the status information, so the UAV may travel in the predetermined trajectory.

By matching the identified type of launch actions with the predetermined trajectories, it is possible to determine the trajectory that the UAV may travel without the need for an additional control device, thereby simplifying the structure of the system and improving the automation process of the UAV operation by using the launch action to select the flight path of the UAV and the corresponding image capturing trajectory.

In an exemplary embodiment of the present disclosure, the predetermined trajectory and/or the predetermined image capturing parameters associated with each type of launch actions of the UAV may be different.

In one embodiment of the present disclosure, as shown in FIG. 6, first, the collection module 100 may collect the status information continuously or intermittently in a sufficiently brief time interval. In particular, the status information collected during the launch process may include, for example, one or more of the following: velocity; acceleration; location; position angle; displacement, distance of the UAV relative to a specified reference object; or the change in the pressure curve of the UAV, etc.

As an example, referring to FIG. 6, the status information collected by the collection module 100 may be used to identify the launch actions of the UAV. For example, the IMU may be used to identify the actions that need to be performed after the launch. Further, determining whether the UAV has been launched may be completed based on the status information.

In one embodiment of the present disclosure, for example, as shown in FIG. 6, the identification module 200 may include a determining module 201 and an identifying module 202, where the determining module 201 may be used to determine whether the UAV has been launched based on the status information; and the identifying module 202 may be used to identify the launch actions of the UAV in the second time period based on the status information. Further, after the determining module 201 determines the UAV has been launched, the launch processing may change from the first time period to the second time period, and the identifying module 202 may start to identify the launch actions of the UAV.

In one embodiment of the present disclosure, the determining module 201 may determine whether the UAV has been launched based on one or more of the following conditions. For example, determining the UAV is free of continuous constraint may include one or more of the following: in response to the UAV being in a state where the acceleration may be substantially the gravitational acceleration, and the velocity is zero or the velocity has a non-zero value without the vertically downward vector, the determining module 201 may determine that the UAV may be free of continuous constraint; in response to the pressure change curve on the UAV has dropped to zero, the determining module 201 may determine that the UAV may be free of continuous constraint; or in response to the distance between the UAV and a specific reference object exceeds the first distance threshold, the determining module 201 may determine that the UAV may be free of continuous constraint.

In particular, in response to the pressure change curve on the UAV has dropped to zero, the determining module 201 may determine that the UAV may be free of continuous constraint may further include: determining whether the pressure change curve on the UAV has gradually approached and substantially conformed to the pressure curve of the predetermined launch process until the pressure reaches zero; or determining whether the pressure change curve on the UAV has reached zero after a predetermined time period.

Through the above exemplary embodiments, the moment at which the UAV is released from the human hand may be effectively determined. Moreover, although only one of the exemplary methods described above is required to effectively determined whether the UAV has left from the human hand, two or more exemplary methods may be used simultaneously to ensure the UAV has left the human hand.

However, in practice, there may be instances where the UAV may unintentionally leave the human hand (e.g., when the user's hand slipped, or when the user encounters a bump on the ground, or when the user tosses the UAV in the hand), but UAV may still be considered as in the hands of the user, such instances may be considered as a “pseudo-launch” state. To avoid the “pseudo-launch” state being identified as an actual launch, whether the UAV has been launched may continue to be determined based on the status information by the determining module 201.

In one embodiment of the present disclosure, for example, when the determining module 201 determines that the UAV is in a state free of continuous constraint, in response to the UAV remains in such state greater than or equal to the first time threshold, the determining module 201 may determine the UAV is released from the human hand and has not been retrieved, thereby substantially entering the launched state. Subsequently, the process may switch from the determining module 201 to the identifying module 202 to identify the launch actions of the UAV.

As an example, the identifying module 202 identifying the launch actions of the UAV may include: detecting one or more of the velocity, acceleration, or displacement of the UAV between the end segment of the first time period and the beginning segment of the second time period, and use the identifying module 202 to identify one or more of the predetermined launch action types of the UAV.

The predetermined types of launch actions may include several basic types. For example, as shown in FIG. 3(b) to FIG. 3(d), the launch action types may include at least: the flat launch, the linear launch, and the circular launch. As shown in FIG. 3(b) to FIG. 3(d), the flat launch may be when the UAV is launched in a horizontally flat state; the linear launch may be when the UAV is launched from the launch point in a generally unidirectional direction; and the circular launch may be when the UAV is launched in a way that spirals outward from a generally specific point (e.g., the launching point).

In the embodiments of the present disclosure, since the velocity and acceleration vectors of the basic types of the three exemplary launch actions described above differ greatly (e.g., whether the speed is not at zero, and the specific operating forms), the identifying module 202 may identify the launch action type based on this principle.

More specifically, the identifying module 202 may identify the launch action type based on one or more of the following conditions. For example, as shown in FIG. 3(b), in response to the UAV maintains in a zero-speed state, the launch action may be identified as the flat launch. As an example, as shown in FIG. 3(c) and FIG. 3(d), in response to the angle between the direction of acceleration of the UAV at the end of the first time period and the direction of the velocity at the beginning of the second period is less than the predetermined angle threshold, the launch action may be identified as the linear launch. Correspondingly, in response to the angle between the direction of acceleration of the UAV at the end of the first time period and the direction of the velocity at the beginning of the second period is greater than the predetermined angle threshold, the launch action may be identified as the circular launch.

As an alternative embodiment, for example, in response to a velocity vector responsive to the UAV at the beginning segment of the second time period including a velocity vector from the position of the UAV away from the position of the UAV at the end segment of the first time period, and the velocity vector has one or more vectors in the horizontal direction and the vertical direction (i.e., there is a component in the horizontal direction or a component in the vertical direction), the launch action may be identified as the linear launch. In addition, in response to the velocity of the UAV at the beginning segment of the second time period including a first velocity vector from the position of the UAV towards the position of the UAV at the end segment of the first time period, and a second velocity vector at an angle (e.g., perpendicular) of the first velocity vector, and the first velocity vector has one or more vectors in the horizontal direction and the vertical direction (e.g., the first velocity vector is a radial velocity component directed to a fixed point, and the second velocity vector is a tangential velocity component perpendicular to the radial velocity component), the launch action may be identified as the circular launch.

Further, in response to the velocity of the UAV at the beginning segment of the second time period including the first velocity vector from the position of the UAV towards the position of the UAV at the end segment of the first time period, and a second velocity vector at an angle (e.g., perpendicular) of the first velocity vector, and the first velocity vector has one or more vectors in the horizontal direction and the vertical direction (e.g., the first velocity vector is a radial velocity component that pointsaway from a fixed point, and the second velocity vector is a tangential velocity component that is perpendicular to the radial velocity component), the launch action may be identified as a curved motion, which may be considered as a combination the linear launch and the circular launch, and the velocity components in the direction of the line between the position of the UAV and the position of the UAV at the end segment of the first time period may deviate from the position of the UAV at the end segment of the first time period.

In an alternative exemplary embodiment, for example, the plurality of predetermined launch action types may include at least: a flat launch, a linear launch, and a circular launch; and the identifying module 202 may be used to identify the plurality of predetermined launch action types may include at least the detection of a motion trajectory of the UAV under a predetermined condition in the first time period to directly identify the type of launch action. More specifically, for example, identifying the type of launch action may include one or more of the following: in response to a state where the motion trajectory of the UAV under the predetermined condition in the first period is a point, the launch action may be determined as the flat launch; in response to a state where the motion trajectory of the UAV under the predetermined condition in the first period is a line, the launch action may be determined as the linear launch; or in response to a state where the motion trajectory of the UAV under the predetermined condition in the first period is a curve, the launch action may be determined as the circular launch. In addition, the initial motion trajectory may be acquired using an IMU carried by the UAV, a Global Navigation Satellite System (GNSS that may include GPS, GLONASS, Galileo, Beidou, etc.).

In one embodiment of the present disclosure, correspondingly, the instruction module 300 may be used to control the movements of the UAV in the second time period, and the respective associated predetermined trajectories may be matched to the identified basic types of exemplary launch actions. More specifically, the predetermined trajectories may include the following basic types: a hover position, a translational trajectory, and a circular trajectory. The hovering position may be, as shown in FIG. 3(b), in response to the launch action being identified the flat launch, the trajectory of the UAV may be controlled to hover at the location at the beginning segment of the second time period. The translational trajectory may be, as shown in FIG. 3(c), in response to the launch action being identified the linear launch, the trajectory of the UAV may be controlled to perform a translational motion starting from the location at the beginning segment of the second time period. The circular trajectory may be, as shown in FIG. 3(d), in response to the launch action being identified the circular launch, the trajectory of the UAV may be controlled to perform a circular motion that may extend helically (for example, a curve that gradually expands outward relative to the center, such as an involute) around a predetermined specific location (for example, the location of the UAV at the beginning segment of the second time period, or the location of the user or device that launch the UAV at the time of the launch).

As an example, the launch action of the linear launch type may be further subdivided to correspond to different launch trajectories. For example, in the embodiments of the present disclosure, as shown in FIG. 4(a) and FIG. 5(a), the linear launch type may be further subdivided into at least one of the following subtypes, namely the lateral launch and the vertical launch. As an example, when the launch action is identified by the identifying module 202 as the linear launch, identifying the type of launch action may include: detecting the direction of the acceleration at the end segment of the first time period or the direction of the velocity at the beginning segment of the second time period to identify the subtype of the linear launch.

In the embodiments of the present disclosure, since the two exemplary subtypes of linear launch described above differ greatly in their respective directivity, it may be possible to further identify the launch action type based on this principle.

In an exemplary embodiment of the present disclosure, the subtype of the linear launch that may be identified by the identifying module 202 may include one or more of the following subtypes. For example, as shown in FIG. 4(a), in response to the UAV having an acceleration in the horizontal direction at the end segment of the first time period, or a velocity in the horizontal direction at the beginning segment of the second time period, the linear launch may be determined to be the lateral launch. In addition, as shown in FIG. 5(a), in response to the acceleration of the UAV at the end segment of the first time period, or the velocity in the beginning segment of the second time period being substantially along the vertical direction, the linear launch may be determined to be the vertical launch. More specifically, for example, an acceleration ratio threshold between the vertical component and the horizontal component of the acceleration vector may be predetermined, or a velocity ratio threshold between the vertical component and the horizontal component of the velocity vector may be predetermined. Thus, in the case where the acceleration ratio between the vertical component and the horizontal component of the actual acceleration vector is greater than the acceleration ratio threshold, it may be determined that the direction of the acceleration is substantially along the vertical direction. Alternatively, when the velocity ratio between the vertical component and the horizontal component of the actual velocity vector is greater than the velocity ratio threshold, it may be determined that the direction of the velocity is substantially along the vertical direction.

In another exemplary embodiment of the present disclosure, for example, as shown in FIG. 4(b) to FIG. 4(c), the lateral launch may be further subdivided into at least two secondary subtypes, namely the soft launch and the hard launch. As an example, when a linear launch is identified as a lateral launch, the identifying module 202 identifying the subtype of the linear launch may include: detecting the direction and magnitude of the velocity at the beginning segment of the second time period, and the integral of the acceleration at the end segment of the first time period along the displacement of the UAV to identify the secondary subtype of the lateral launch.

More specifically, in one embodiment of the present disclosure, the identifying module 202 may identify the secondary subtype of the lateral launch based on one or more of the following conditions. As shown in FIG. 4(b), in response to the velocity of the UAV is substantially along the horizontal direction, and the magnitude of the velocity does not exceed the first speed threshold, or the integral of the acceleration along the displacement of the UAV at the end segment of the first time period not exceeding the first integral threshold, the lateral launch may be identified as the soft launch. In addition, as an example, as shown in FIG. 4(c), in response to the UAV's velocity having a horizontal component, and the speed is greater than or equal to the first speed threshold, or the integral of the acceleration along the displacement of the UAV at the end segment of the first time period being equal to or exceeding the first integral threshold, the lateral launch may be identified as the hard launch. In another embodiment, in response to the UAV's velocity having a horizontal component, and the speed is less than or equal to the first speed threshold, or the integral of the acceleration along the displacement of the UAV at the end segment of the first time period is less than the first integral threshold, the lateral launch may be identified as a combination of a soft launch in the horizontal direction and a vertical launch in the vertical direction. Since there may be a difference in the initial velocities of the UAV in the beginning segment of the second time period between the soft launch and the hard launch, that is, there may be a difference in the integral of the acceleration along the displacement of the UAV at the end segment of the first time period, therefore, by defining the first speed threshold or the first integral threshold, it may be possible to distinguish whether the UAV is soft-launched or hard-launched when the UAV has been identified as laterally-launched.

In the embodiment of the present disclosure, correspondingly, when a linear launch is identified as a lateral launch, the lateral trajectory may include the soft launch trajectory and the hard launch trajectory. The soft launch trajectory may be, as shown in FIG. 4(b), in response to the lateral launch being identified as a soft launch, the UAV may start the horizontal travel from the location at the beginning segment of the second time period, and the horizontal displacement may be the first predetermined distance. The hard launch trajectory may be, as shown in FIG. 4(c), in response to the lateral launch being identified as a heavy launch, the UAV may start the oblique travel that may be inclined at an angle with respect to the horizontal direction from the position at the beginning segment of the second time period, and the horizontal displacement may be the second predetermined distance that may be greater than the first predetermined distance. In some embodiments, for example, different first predetermined distances and second predetermined distances may be pre-stored in a corresponding “Launch Action Type vs. Predetermined Trajectory” lookup table in the storage in the onboard control device 15 of the UAV as a parameter of the predetermined trajectory of the lateral launch.

In another embodiment of the present disclosure, for example, as shown in FIG. 5(b) to FIG. 5(c), the vertical launch may be further subdivided into at least two secondary subtypes, namely the soft push launch and the hard push launch.

As an example, when a linear launch is identified as a vertical launch, the identifying module 202 identifying the subtype of the linear launch may further include: detecting the velocity at the beginning segment of the second time period, and/or the integral of the acceleration at the end segment of the first time period along the displacement of the UAV to identify the secondary subtype of the vertical launch.

More specifically, in the embodiment of the present disclosure, the identifying module 202 identifying the secondary subtype of the vertical launch may include one or more of the following conditions. As shown in FIG. 5(b), in response to the speed of the UAV does not exceed the second speed threshold, or the integral of the acceleration at the end segment of the first time period along the displacement of the UAV does not exceed the second integral threshold, the vertical launch may be identified as the soft push launch. In addition, as an example, as shown in FIG. 5(c), in response to the speed of the UAV is greater than or equal to the second speed threshold, or the integral of the acceleration at the end segment of the first time period along the displacement of the UAV is greater than or equal to the second integral threshold, the vertical launch may be identified as the hard push launch.

Since there may be a difference in the initial vertical velocities of the UAV at the beginning segment of the second time period between the soft push launch and the hard push launch, that is, there may be a difference in the integral vertical acceleration along the displacement of the UAV at the end segment of the first time period, therefore, by defining the second speed threshold or the second integral threshold, it may be possible to distinguish whether the UAV is soft push-launched or hard push-launched when the UAV has been identified as vertically-launched.

In one embodiment of the present disclosure, correspondingly, when a linear launch is identified as the vertical launch, the vertical trajectory may include the soft push launch trajectory and the hard push launch trajectory. The soft push launch trajectory may be, as shown in FIG. 5(b), in response to the vertical launch being identified as the soft push launch, the UAV may perform the vertical travel with a vertical displacement of a third predetermined distance from the location at the beginning segment of the second time period. Further, the hard push launch trajectory may be, as shown in FIG. 5(c), in response to the vertical launch being identified as the hard push launch, the UAV may perform the vertical travel with a vertical displacement of a fourth predetermined distance, which is greater than the third predetermined distance, from the location at the beginning segment of the second time period. In some embodiments, for example, different third predetermined distances and fourth predetermined distances may be pre-stored in a corresponding “Launch Action Type vs. Predetermined Trajectory” lookup table in the storage in the onboard control device 15 of the UAV as a parameter of the predetermined trajectory of the lateral launch.

In one embodiment of the present disclosure, for example, the instruction module 300 controlling the UAV to move along the predetermined trajectory may include: in response to identifying a single launch action, the instruction module 300 may control the UAV to follow the associated predetermined trajectory; or, in response to identifying two or more single launch actions, the instruction module 300 may control the UAV to follow a combination of the two or more associated predetermined trajectories. For example, the “Launch Action Type vs. Predetermined Trajectory” lookup table pre-stored in the storage of the onboard control device 15 of the UAV may be searched to find one or more predetermined trajectories that may match the launch action type during the launch process; in response to identifying two or more single launch action types, the instruction module 300 may control the UAV to move according to a combination of predetermined trajectories in the second time period.

In addition, in one embodiment of the present disclosure, for example, while controlling the UAV to move according to the predetermined trajectory, the image capturing device carried by the UAV may be controlled to capture images based on the predetermined image capturing parameters. For example, the predetermined image capturing parameters may be used to capture the panoramic view of the environment in which the target may be located. As an example, each launch action type may be associated with a predetermined image capturing parameter; and the instruction module 300 may control the image capturing device carried by the UAV to capture images based on the predetermined image capturing parameters. More specifically, for example, when the UAV is launched from the launch point (e.g., the final position of the user's hand at the time of the launch) and is flying around the launch point, the carrier 12 (e.g., a PTZ) of the UAV along with the load 13 (e.g. a camera) it carries in combination may lock on an operating target (e.g., an object to be photographed). More specifically, for example, the predetermined image capturing parameters may include predetermined composition rules to ensure the target may be in the predetermined composition position when the UAV is traveling in the associated predetermined trajectory. For example, the composition rules may divide the viewing field of the camera into two or more sub-areas using one or more lines (e.g., dichotomy composition, or quadrature composition), or a grid area using a plurality of lines (e.g., a nine-square grid pattern, or a 4×4 gird composition), and place a predetermined composition point, for example, at intersections where lines intersect, as the target to which the camera may be aiming. For example, the instruction module 300 may control the trajectory of the UAV or the pitch of the PTZ to execute the composition rules.

More specifically, in the embodiments of the present disclosure, for example the composition rules may include the target being substantially in front of the nose of the UAV, and the instruction module 300 may be used to adjust the position of the UAV in the associated predetermined trajectory or the combination of the associated predetermined trajectories using the composition rules based on the status information of the UAV; and further adjust the horizontal position and the tilt angle of the image capturing device carried by the UAV to ensure the target may be in the predetermined composition position. Therefore, it may be possible to accurately and quickly place the target into the desired composition position based on the predetermined composition rules efficiently without an additional external control device and related manual control operations, thereby completing the imaging capture tasks of the UAV with the highest efficiency. For example, the distant view to be photographed may be placed at a position approximately ⅓ of the imaging capturing window of the image capturing device.

In one embodiment of the present disclosure, the instruction module 300 may further include a height adjusting module that may be used to control the propulsion unit of the UAV to operate in an idle state based on the detected position of the UAV in response to the determining the UAV has not been launched; and, use an open-loop control method to control the propulsion unit of the UAV to quickly increase the output power from the idle state so the height of the UAV may substantially reach the height of an associated predetermined trajectory or a combination of the associated predetermined trajectories within a predetermined second time threshold in response to determining the UAV has been launched and the UAV is in the second time period. Due to the open-loop control method, the second time threshold may be set to be less than a closed-loop control method. To ensure the accuracy and convergence of the height adjustment of the UAV, a closed-loop control method may be added at the end of the height adjustment.

In one embodiment of the present disclosure, the instruction module 300 may further include a travel determination module that may be used to determine the location of the UAV in the associated predetermined trajectory based on the collected status information.

In one embodiment of the present disclosure, the instruction module 300 may further include a speed adjustment module that may be used to adjust the speed of the UAV in response to the result of the determination of the location of the UAV in the associated predetermined trajectory before the UAV reaches the end point. For example, the speed adjustment module may decelerate the UAV before reaching the end point; decelerate at a constant or variable speed; or, accelerate followed by decelerate. In addition, the speed adjustment of the UAV may include using the close-loop control method to control the UAV to terminate the travel at the end point of the predetermined trajectory and remain hovering. In addition, the close-loop control method may include one of the following control methods: a Proportional Integral Derivative (PID) control, or a Proportional Derivative (PD) control.

In addition, the instruction module 300 may control the UAV in the second time period to return to the location at the beginning segment to the second time period, or return to a predetermined end locate after reaching the end point.

In one embodiment of the present disclosure, the instruction module 300 may further include a self-stabilizing module that may be used to perform the following tasks: after determining the location of the UAV is in the associated predetermined trajectory to determine that the UAV has not reach the end point of the respective predetermined trajectory, based on the collected status information, using a position algorithm, calculate the difference of the pitch axis and the roll axis of the UAV between at the current position and the position at the end of the first time period; correspondingly adjusting the pitch axis and the roll axis of the UAV to a predetermined angle range; and control the UAV's propulsion unit so the UAV may maintain a self-stabilizing state parallel to the ground.

In one embodiment of the present disclosure, the instruction module may further include a triggering module that may be used to monitor a trigger signal of the UAV in real time, and in response to detecting the trigger signal of the UAV, start the collection module 100 of the UAV and start to collect the status information of the UAV during the launch process.

In some embodiments, the trigger signal may include one or more of the following: tapping the UAV one or more times; clicking a power button or a control button of a control device in communication with the UAV one or more times; drawing a predetermined pattern on a touch screen or a touch panel of the control device; recognizing human body features of the user and compare them to the stored user features (e.g., face recognition, voice recognition, fingerprint recognition, iris recognition, scleral recognition, etc.), or the combinations thereof.

In addition, the determination module 200 may further include a attitude angle determination module. More specifically, the status information may include the launch angle of the UAV, and the attitude angle determination module may be used to determine whether the attitude angle of the UAV is within a range of attitude angle thresholds suitable for safely unlocking the UAV, and in response to a attitude angle exceeding the range of attitude angle thresholds, send an alarm signal and restart the triggering module.

The foregoing advantages of the method for controlling the launching of the UAV may be implemented by the above-described apparatus to control the launch of the UAV and will not be described herein.

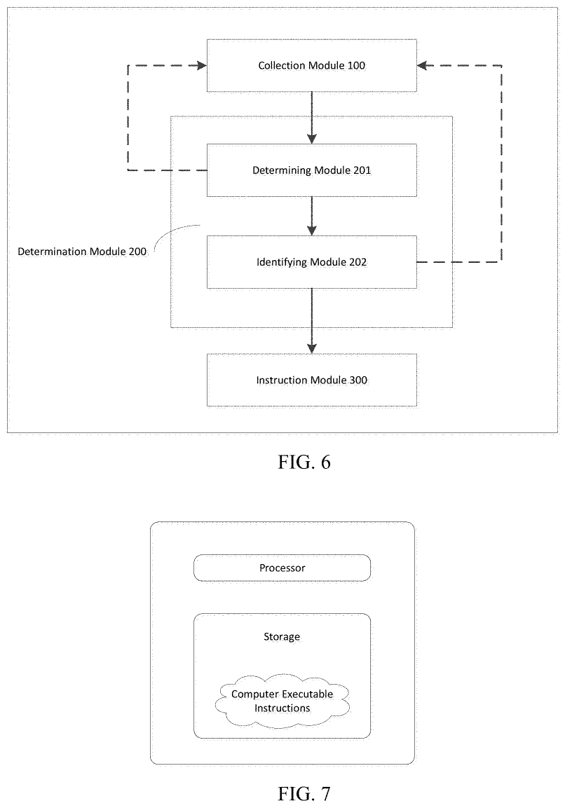

Another aspect of the present disclosure provides an onboard UAV control device, such as the control device 15 in FIG. 1. As shown in FIG. 7, the onboard UAV control device includes a storage that may be used to storage computer executable instructions; and a processor that may be used to execute the computer executable instructions stored in the storage to perform the aforementioned UAV control method.

It should be noted that those skilled in the art can understand all or part of the process in implementing the above embodiments. For example, collecting the status information of the UAV during the launch process in Step S100; identifying the launch actions in Step S200 (such as determining whether the UAV has been launched in Step S201 and identifying the launch action in Step S202); and controlling the movements of the UAV during the second time period in Step S300 may be performed by instructing the related hardware through computer executable instructions. The computer executable instructions may be stored in a computer readable storage medium, which, when executed, may include the embodiments of the UAV control method described above. The storage medium may be, for example, a magnetic disk, an optical disk, a hard disk drive, a flash memory, a read-only memory (ROM), or a random access memory (RAM).

In addition, functions described in the various embodiments of the present disclosure may be implemented by dedicated hardware or a combination of general-purpose hardware and software. For example, functions described that may be implemented by dedicated hardware (for example, a Field Programmable Gate Array (FPGA), an Application-Specific Integrated Circuit ASIC, etc.) may be implemented by general-purpose hardware (for example, a Central Processing Unit (CPU), a microprocessor (μP), or a Digital Single Processor (DSP)) in combination with software, and vice versa. Further, functions described that may be implemented by a dedicate processor such as a WiFi chip, a Bluetooth module, a NFC chip/coil, etc. may be implemented by a general-purpose processor (e.g., CPU, DSP, etc.) in combination with hardware such as analog-to-digital conversion circuit, amplifier circuit, antenna, and related processing software for Bluetooth, NFC, and WiFi, and vice versa.

Another aspect of the present disclosure provides UAV system. The UAV system includes a UAV body 11; a propulsion unit 14 mounted on the UAV body 11; and an aforementioned control device 15.

In some embodiments, the propulsion unit 14 may include one of the following: a motor, an electronic speed control, or a propeller. Further, the UAV system may further include an onboard image capturing device.

In addition, in the above detailed descriptions, for purposes of explanation, many specific details are set forth in order to provide a thorough understanding of the embodiments of the present disclosure. However, it will be apparent that one or more embodiments may be practiced without these specific details.

Those of ordinary skill in the art will appreciate that the example elements and algorithm steps described above can be implemented in electronic hardware, or in a combination of computer software and electronic hardware. Whether these functions are implemented in hardware or software depends on the specific application and design constraints of the technical solution. One of ordinary skill in the art can use different methods to implement the described functions for different application scenarios, but such implementations should not be considered as beyond the scope of the present disclosure.

For simplification purposes, detailed descriptions of the operations of example systems, devices, and units may be omitted and references can be made to the descriptions of the example methods.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit.

A method consistent with the disclosure can be implemented in the form of computer program stored in a non-transitory computer-readable storage medium, which can be sold or used as a standalone product. The computer program can include instructions that enable a computer device, such as a personal computer, a server, or a network device, to perform part or all of a method consistent with the disclosure, such as one of the example methods described above. The storage medium can be any medium that can store program codes, for example, a USB disk, a mobile hard disk, a read-only memory (ROM), a random access memory (RAM), a magnetic disk, or an optical disk.

Other embodiments of the disclosure will be apparent to those skilled in the art from consideration of the specification and practice of the embodiments disclosed herein. It is intended that the specification and examples be considered as example only and not to limit the scope of the disclosure, with a true scope and spirit of the invention being indicated by the following claims.

What is claimed is:

1. An UAV control method, comprising:
collecting status information of an UAV during a launch process, the launch process including at least a first time period during which the UAV has not been launched and is under constraint, and a second time period during which the UAV has been launched and is free of constraint;
identifying one or more launch actions based on the status information; and
controlling movements of the UAV in the second time period based on the identified launch actions.

2. The method of claim 1, wherein controlling the movements of the UAV in the second time period includes:
in response to identifying the one or more launch actions of the UAV, associating the one or more launch actions of the UAV with one or more trajectories of the UAV, and controlling the UAV to move according to the trajectories.

3. The method of claim 2, wherein the status information includes one or more of the following information: velocity, acceleration, location, displacement including a distance of the UAV relative to a specific reference object, or a pressure change curve on the UAV.

4. The method of claim 3, further comprising:
determining whether the UAV has been launched in the first time period; and
in response to determining the UAV has been launched, the launch process switches from the first time period to the second time period and starts to identify the one or more launch actions of the UAV.

5. The method of claim 4, wherein determining whether the UAV has been launched includes:
determining whether the UAV is free of constraint, which includes one or more of the following conditions:
in response to the acceleration of the UAV being the gravitational acceleration, and the velocity being zero or the velocity having a non-zero value without a vertically downward vector, the UAV is free of constraint;
in response to the pressure change curve on the UAV having dropped to zero, the UAV is free of constraint;
in response to the distance between the UAV and the specific reference object exceeding a first distance threshold, the UAV is free of constraint; or
after determining the UAV is free of constraint, in response to the UAV having remained to be free of continuous constraint longer than a first time threshold, determine the UAV has been launched.

6. The method of claim 3, wherein identifying the one or more launch actions of the UAV includes:
detecting one or more of the velocity, acceleration, or the displacement between an end segment of the first time period and a beginning segment of the second time period to identify the one or more of a plurality of launch actions types of the UAV.

7. The claim of method 6, wherein
identifying the one or more of the plurality of launch action types includes one or more of the following:
detecting one or more of a direction of acceleration and a direction of velocity at the end segment of the first time period; or
detecting a direction of velocity in the beginning segment of the second time period.

8. The method of claim 7, wherein identifying the plurality of launch action types includes one or more of the following:
in response to the UAV maintaining in a zero-speed state, the launch action is identified as a flat launch;
in response to an angle between the direction of acceleration of the UAV at the end segment of the first time period and the direction of the velocity at the beginning segment of the second period being less than a predetermined angle threshold, the launch action is identified as a linear launch; or
in response to the angle between the direction of acceleration of the UAV at the end segment of the first time period and the direction of the velocity at the beginning segment of the second period being greater than the predetermined angle threshold, the launch action is identified as a circular launch.

9. The method of claim 6, wherein identifying the one or more of the plurality of launch action types includes:
detecting a motion trajectory of the UAV under a predetermined condition in the first time period.

10. The method of claim 9, wherein identifying the plurality of launch action types includes one or more of the following:
in response to the motion trajectory of the UAV under the predetermined condition in the first time period being a point, the launch action is identified to be a flat launch;
in response to the motion trajectory of the UAV under the predetermined condition in the first time period being a straight line, the launch action is identified to be the linear launch; or
in response to the motion trajectory of the UAV under the predetermined condition in the first period time being a curve, the launch action is determined to be a circular launch.

11. The method of claim 7, wherein the trajectories include:
a hovering position, wherein in response to the launch action being the flat launch, the UAV is controlled to hover at a location at the beginning segment of the second time period;
a translational trajectory, wherein in response to the launch action being the linear launch, the UAV is controlled to perform a translational motion starting from the location at the beginning segment of the second time period; and
a circular trajectory, wherein in response to the launch action being the circular launch, the UAV is controlled to perform a circular motion that extends helically around a specific location.

12. The method of claim 11, wherein in response to the launch action being identified as the linear launch, identifying the launch action types includes one or more of the following:
detecting the direction of the acceleration at the end segment of the first time period or the direction of the velocity at the beginning segment of the second time period, identifying a subtype of the linear launch, wherein identifying the subtype of the linear launch includes one or more of the following:
in response to the UAV having an acceleration in the horizontal direction at the end segment of the first time period, or a velocity in the horizontal direction at the beginning segment of the second time period, the linear launch is identified as a lateral launch; or
in response to the acceleration of the UAV at the end segment of the first time period, or the velocity in the beginning segment of the second time period being along the vertical direction, the linear launch is identified as a vertical launch.

13. The method of claim 11, wherein controlling the UAV to move according to the trajectories further includes:
in response to identifying one launch action, control the UAV to move along an associated trajectory; or,
in response to identifying two or more launch actions, control the UAV to move along a combination of the two or more associated trajectories.

14. The method of claim 2, wherein each launch action type is associated with the one or more of plurality of image capturing parameters, and the method further comprises:
controlling an image capturing device carried by the UAV to capture images based on the image capturing parameters, where the image capturing parameters includes composition rules to ensure a target is in a composition position when the UAV is moving along the associated trajectory.

15. The method of claim 14, wherein the composition rules includes the target being in front of the nose of the UAV, and controlling the movements of the UAV in the second time period includes:
adjusting the position of the UAV in the associated trajectory or a combination of the associated trajectories based on the status information of the UAV using the composition rules; and
further adjusting a horizontal position and a tilt angle of the image capturing device carried by the UAV to ensure the target is in the composition position.

16. The method of claim 4, further includes adjusting the height of the UAV, wherein adjusting the height of the UAV includes:
in response to the determining the UAV having not been launched, control a power source of the UAV to operate in an idle state based on the detected location of the UAV; and
in response to determining the UAV having been launched and the UAV being in the second time period, use an open-loop control method to control the power source of the UAV to increase the output power from the idle state to control the height of the UAV to reach the height of the associated trajectory or a combination of the associated trajectories within a second time threshold.

17. The method of claim 2, wherein controlling the movements of the UAV in the second time period includes:
determining the location of the UAV in the associated trajectory based on the collected status information;
in response to the result of the determination of the location of the UAV being in the associated trajectory, adjust the speed of the UAV to control the UAV to terminate the movements at an end point of the trajectory, wherein terminating the movements is to maintain the UAV in a hovering state.

18. The method of claim 1, wherein the method further includes triggering a movement of the UAV prior to collecting the status information during the launch process, including:
monitoring a triggering signal of the UAV; and
in response to detecting the trigger signal of the UAV, start the UAV and begin collecting the status information of the UAV during the launch process.

19. An apparatus for controlling an UAV, embedded in the UAV, comprising:
a storage to store computer executable instructions; and
a processor to execute the computer executable instructions stored in the storage to execute an UAV control method comprising:
collecting status information of a UAV during a launch process, the launch process including at least a first time period during which the UAV has not been launched and is under constraint, and a second time period during which the UAV has been launched and is free of constraint;
identifying one or more launch actions based on the status information; and
controlling movements of the UAV in the second time period based on the identified launch actions.

20. An UAV system, comprising:
an UAV body;
a propulsion unit placed in the UAV body; and
a controller placed in the UAV body, wherein the controller comprises:
a storage to store computer executable instructions; and
a processor to execute the computer executable instructions stored in the storage to execute an UAV control method comprising:
collecting status information of a UAV during a launch process, the launch process including at least a first time period during which the UAV has not been launched and is under constraint, and a second time period during which the UAV has been launched and is free of constraint;
identifying one or more launch actions based on the status information; and
controlling movements of the UAV in the second time period based on the identified launch actions.
